(19) United States
(12) Patent Application Publication
(10) Pub. No.: US 2003/0163326 A1
(43) Pub. Date: Aug. 28, 2003

(54) Electrical appliance, in particular, a ventilator hood

(76) Inventor: Jens Maase, Regensburg (DE)

Correspondence Address: LERNER AND GREENBERG, P.A., POST OFFICE BOX 2480, HOLLYWOOD, FL, 33022-2480, US

(21) Appl. No.: 10/375,545

(22) Filed: Feb. 27, 2003

(30) Foreign Application Priority Data
Feb. 27, 2002 (DE) 102 08 465.3

(51) Int. Cl. G10L 21/00

(52) U.S. Cl. 704/275

(57) ABSTRACT

A ventilator hood includes a voice operating unit with a microphone. The microphone is a spatially selective sound pickup.

### BACKGROUND OF THE INVENTION

### Field of the Invention

The invention relates to an electrical household appliance, in particular, a ventilator hood, with a voice input unit having a microphone.

International publication WO 01/59763 A1 discloses an electrical appliance with a voice input unit. Connected downstream of the voice input unit is a voice processing unit that uses spoken input commands to derive control signals for controlling functions of the household appliance. An operational status detection unit is provided that detects the operational status of the household appliance or other noise sources, and reports to the voice processing unit. The voice processing unit undertakes an interference noise correction only if a noise source is switched on. The prior art method for voice input with correction of interference signals is characterized in that the operational status of at least one noise source that interferes with the voice input is interrogated during the voice input for controlling an appliance, and in that the voice processing unit undertakes an interference noise correction only if a noise source is switched on. Thus, if a voice signal is submitted to the voice processing unit for recognition, an attempt is not made in each case to undertake an interference noise correction. This leads to an improvement in the voice recognition in all cases in which the voice signal is not loaded at all by interference noises. This is because the quality of the voice signal is reduced by the effort to remove nonexistent interference noise from the voice signal, or to take correcting account of it.

A problem arises in a household when various appliances are controlled by voice or when appliances output voice signals. The reliability of the recognition of the voice control is, then, negatively influenced by extraneous noise. This noise is produced by “crosstalk” between people, or by the radio, the television set or, else, by other appliances operated in the surroundings. It is known from the prior art to use a so-called push-to-talk key in order largely to suppress such interference. Only as long as an operator presses this key and talks does the voice operating unit pick up voice signals. However, it is not possible thereby to suppress synchronously occurring interference. Moreover, it is necessary for the operator to keep the key pressed continuously while speaking.

### SUMMARY OF THE INVENTION

It is accordingly an object of the invention to provide an electrical appliance, in particular, a ventilator hood, that overcomes the hereinafore-mentioned disadvantages of the heretofore-known devices of this general type and with which an improvement is achieved in picking up voice signals in the household field.

With the foregoing and other objects in view, in an electrical household appliance, there is provided, in accordance with the invention, a voice-activation unit including a voice operating unit having a microphone for receiving sound signals, the microphone being a spatially selective sound pickup. In particular, the appliance is a ventilator hood.

In the case of an electrical household appliance of the type mentioned at the beginning, according to the invention, the microphone is a spatially selective sound pickup.

The invention achieves a limitation of the region where voice signals are picked up. Consequently, extraneous noises that could lead to undesired control commands in the household appliance are excluded from accidental detection.

In accordance with another feature of the invention, a household appliance is fitted with a spatially selective, passive sound pickup and proves to be advantageous. The sound pickup is connected upstream of the microphone or the microphone array and ensures selective focusing of the sound waves irradiated from a prescribed region of space.

In accordance with a further feature of the invention, the sound pickup is an active sound pickup with a microphone array.

A configuration of the household appliance in which the sound pickup includes at least two sound surfaces is particularly suitable. The surfaces are input surfaces for receiving the sound signals.

In accordance with an added feature of the invention, the at least two sound surfaces are, preferably, disposed at right angles to one another.

In accordance with an additional feature of the invention, it proves to be advantageous when there is present at the household appliance an evaluation unit by which the sound signals picked up by the sound surfaces can be combined with one another by computation rules.

In accordance with a concomitant feature of the invention, the signals picked up by the sound surfaces can be attenuated in accordance with a preset direction.

With the objects of the invention in view, in a ventilator hood, there is also provided a a voice-activation unit including a voice operating unit having a microphone that is a spatially selective sound pickup having at least two input surfaces for receiving the sound signals, the at least two input surfaces being disposed at right angles to one another, the sound pickup attenuating the sound signals picked up by the at least two input surfaces, and an evaluation unit connected to the at least two input surfaces, the evaluation unit combining the sound signals picked up by the at least two input surfaces with one another.

Other features that are considered as characteristic for the invention are set forth in the appended claims.

Although the invention is illustrated and described herein as embodied in an electrical appliance, in particular, a ventilator hood, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a fragmentary, perspective view of a configuration including a ventilator hood and a cooking surface according to the invention;

FIG. 2 is a diagrammatic perspective illustration of a microphone with a sound fan according to the invention;

FIG. 3 is a diagrammatic perspective illustration of an alternative orientation of the microphone of FIG. 2;

FIG. 4 a diagrammatic perspective illustration of an alternative embodiment of the microphones of FIGS. 2 and 3;

FIG. 5A is a diagrammatic illustration of a voice signal before processing according to the invention; and

FIG. 5B a diagrammatic illustration of a voice signal after processing according to the invention.

### DESCRIPTION OF THE PREFERRED EMBODIMENTS

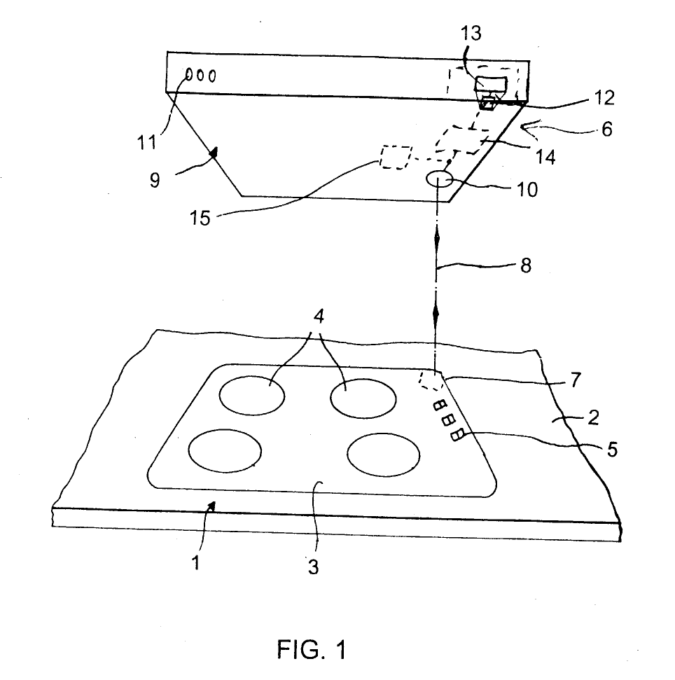

Referring now to the figures of the drawings in detail and first, particularly to FIG. 1 thereof, there is shown a cooking surface 1 is mounted in a cutout of an operating plate 2. Various cooking zones 4 are marked on a cooking surface plate 3, which is made from glass ceramic, in particular. Depending on the inputs through an operating and display unit 5 of the cooking surface 1, non-illustrated cooking vessels that are placed on the cooking zones 4 can be heated in a manner known per se by non-illustrated heating elements that are disposed underneath the cooking surface plate 3, through the control unit. Here, the operating and display unit 5 is present for reasons of comfort and safety. It may be reduced to the minimum that is prescribed for safety equipment, in the which, the overall configuration also has a voice operating unit 6 as described below.

In the cooking surface 1 there is also a transceiver unit 7, which communicates in a manner known per se through a transmission link 8, operating in a wireless fashion, with a ventilator hood 9 disposed above the cooking surface 1. The transmission link 8 can be implemented, for example, as a radio link in this case. To communicate with the cooking surface 1, the ventilator hood 9 has a transceiver unit 10. The ventilator hood 9, likewise, has operating and display elements 11, through which functions of the ventilator hood 9 are actuated and/or displayed. To permit a voice input, the voice operating unit 6 has a microphone 12 that is disposed spatially downstream of an optical sensor 13. Signals picked up by the microphone 12 are fed to a voice recognition unit 14. The voice recognition unit 14 is connected to a voice evaluation unit 15, which derives a signal for controlling the ventilator hood 9 and/or the cooking surface 1 from the received voice signal. In the latter case, the signal is transmitted to the cooking surface 1 through the transmission link 8.

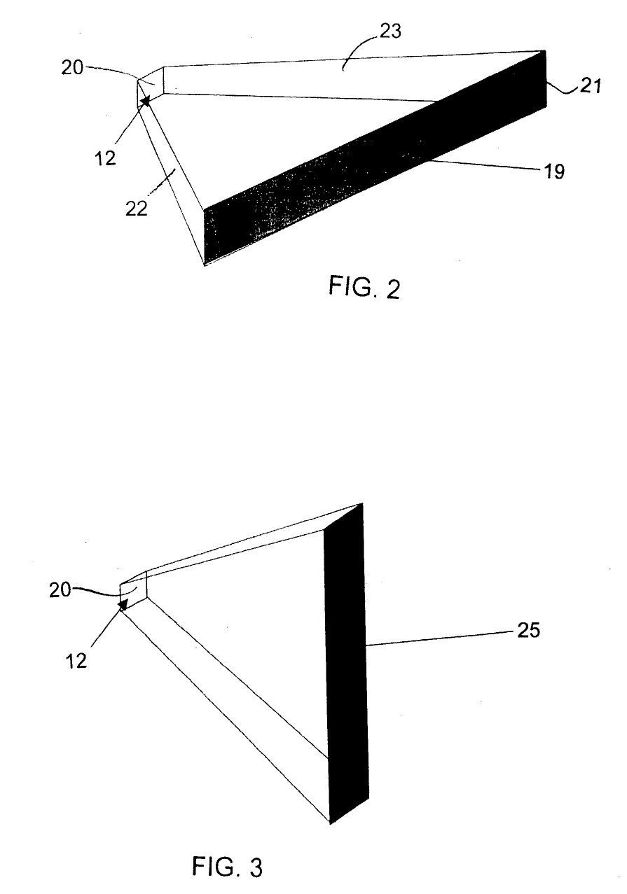

To achieve better sound pickup that is selective by comparison with conventional microphones, there is connected upstream of the microphone 12 a spatially selective sound pickup 19 (FIG. 2) that leads the voice signals onto an input surface 20 of the microphone 12. The sound pickup 19 has an input surface 21 and side walls 22, 23 that run up, at an acute angle to the surface 21, onto the input surface 20 of the microphone 12 such that the sound pickup 19 overall has the plan of a trapezoid. It goes without saying that the side walls can also be curved and can, for example, have the shape of parabolic branches. A very good sound pickup is achieved when the microphone is disposed at the focal point of such a parabola.

In the simplest case, the microphone 12 is a passive directional microphone. In a more complicated case, an active directional microphone is used. This active directional microphone is, preferably, a microphone array. The direction of the microphone array can, preferably, be pivoted. Sound is, then, picked up only when the sound source is situated upstream of the input surface 20 of the sound pickup 19. Interference sources that are not located upstream of the input surface 21 of the sound pickup 19 are strongly attenuated, and are, therefore, no longer in the region of detection for the voice recognition of the voice operating unit 6.

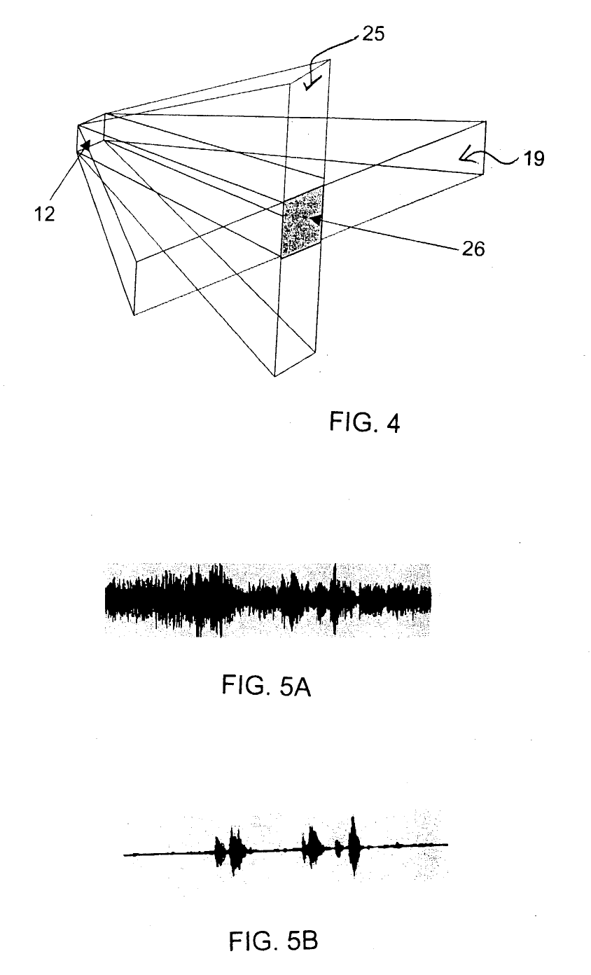

The region where voice signals are received is further limited by a combination of the sound pickup 19 with a sound pickup 25, disposed perpendicular to the latter, together with appropriate active evaluation by an active microphone array of the microphone 12. For such a purpose, two microphone arrays are connected to one another at an angle of 90 degrees (FIG. 4). The received signals are combined with one another using known algorithms. Use is made of the same algorithms as in the case of a single microphone array. A sharply delimited sound lobe is formed by the use of the two microphone arrays disposed at a right angle to one another. A central sensitive region 26 is produced by the combination of the two microphone arrays of the sound pickups 19 and 25. Because the direction of the active microphone arrays can be pivoted very easily, an electronically pivotable directional microphone results. In difficult cases, this can be adjusted to the conditions in the room with the aid of a service.

The selection of the valid signals is greatly improved by the limitation of the signals that can be evaluated. Signals that come from a direction other than the preset one are so strongly attenuated that, for example, a radio that is playing and rendering voice recognition impossible is completely cut out in the room. FIGS. 5A and 5B respectively illustrate a voice signal spectrum before and after processing according to the invention.

I claim:

1. In an electrical household appliance, a voice-activation unit comprising:
a voice operating unit having a microphone for receiving sound signals, said microphone being a spatially selective sound pickup.

2. The household appliance according to claim 1, wherein said sound pickup is a spatially passive sound pickup.

3. The household appliance according to claim 1, wherein said sound pickup is an active sound pickup with a microphone array.

4. The household appliance according to claim 3, wherein said sound pickup has at least two input surfaces for receiving the sound signals.

5. The household appliance according to claim 4, wherein said at least two input surfaces are disposed at right angles to one another.

6. The household appliance according to claim 5, further comprising an evaluation unit connected to said at least two input surfaces, said evaluation unit combining sound signals picked up by said at least two input surfaces with one another by computation rules.

7. The household appliance according to claim 5, further comprising an evaluation unit connected to said at least two input surfaces, said evaluation unit combining the sound signals picked up by said at least two input surfaces with one another.

8. The household appliance according to claim 1, wherein said sound pickup attenuates the sound signals picked up by said at least two input surfaces in accordance with a preset direction.

9. The household appliance according to claim 1, wherein said sound pickup attenuates the sound signals picked up by said at least two input surfaces.

10. The household appliance according to claim 7, wherein said sound pickup attenuates the sound signals picked up by said at least two input surfaces in accordance with a preset direction.

11. In a ventilator hood, a voice-activation unit comprising:
a voice operating unit having a microphone that is a spatially selective sound pickup.

12. The hood according to claim 11, wherein said sound pickup is a spatially passive sound pickup.

13. The hood according to claim 11, wherein said sound pickup is an active sound pickup with a microphone array.

14. The hood according to claim 13, wherein said sound pickup has at least two input surfaces for receiving the sound signals.

15. The hood according to claim 14, wherein said at least two input surfaces are disposed at right angles to one another.

16. The hood according to claim 15, further comprising an evaluation unit connected to said at least two input surfaces, said evaluation unit combining sound signals picked up by said at least two input surfaces with one another by computation rules.

17. The hood according to claim 15, further comprising an evaluation unit connected to said at least two input surfaces, said evaluation unit combining the sound signals picked up by said at least two input surfaces with one another.

18. The hood according to claim 11, wherein said sound pickup attenuates the sound signals picked up by said at least two input surfaces in accordance with a preset direction.

19. The hood according to claim 11, wherein said sound pickup attenuates the sound signals picked up by said at least two input surfaces.

20. The hood according to claim 17, wherein said sound pickup attenuates the sound signals picked up by said at least two input surfaces in accordance with a preset direction.

21. In a ventilator hood, a voice-activation unit comprising:
a voice operating unit having a microphone that is a spatially selective sound pickup having at least two input surfaces for receiving the sound signals, said at least two input surfaces being disposed at right angles to one another, said sound pickup attenuating the sound signals picked up by said at least two input surfaces; and
an evaluation unit connected to said at least two input surfaces, said evaluation unit combining the sound signals picked up by said at least two input surfaces with one another.

22. The hood according to claim 21, wherein said sound pickup is a spatially passive sound pickup.

23. The hood according to claim 21, wherein said sound pickup is an active sound pickup with a microphone array.

24. The hood according to claim 21, wherein said evaluation unit combines sound signals picked up by said at least two input surfaces with one another by computation rules.

25. The hood according to claim 21, wherein said sound pickup attenuates the sound signals picked up by said at least two input surfaces in accordance with a preset direction.
